(19) United States
(12) Patent Application Publication
(10) Pub. No.: US 2006/0288814 A1
(43) Pub. Date: Dec. 28, 2006

(54) Lever apparatus in a motor vehicle

(76) Inventors: Torsten Frobel, Hamburg (DE); Thomas Ropke, Stelle (DE); Michael Siemers, Buchholz (DE)

Correspondence Address: AKERMAN SENTERFITT, P.O. BOX 3188, WEST PALM BEACH, FL, 33402-3188, US

(21) Appl. No.: 10/569,158

(22) PCT Filed: Aug. 4, 2004
(86) PCT No.: PCT/EP04/08723

§ 371 Date: Jul. 27, 2006

(30) Foreign Application Priority Data
Aug. 21, 2003 (DE) 103 38 384.0

(51) Int. Cl. G05G 1/14

(52) U.S. Cl. 74/560

(57) ABSTRACT

The invention relates to a lever apparatus (1) in a motor vehicle, with a carrier component (2) holding a bearing element (5) on which an actuating lever (4) of the lever apparatus (1) is pivotably fastened. In order to simplify the production of the lever apparatus (1), it is proposed that the carrier component (2) has an opening (14) through which the bearing element (5) protrudes, and that the bearing element (5) is a hollow sheet metal part which has at least one laterally protruding supporting means (16) which bears against a rear side (17) of the carrier component (2). The actuating lever (4) on the bearing element (5) is axially enclosed between the front side (18) of the carrier component (2) and a retaining part (9) arranged on the bearing element (5).

### CROSS REFERENCE TO RELATED APPLICATION

This application is a national stage of PCT/EP2004/008723 filed Aug. 4, 2004 and based upon DE 103 38 384.0 filed Aug. 21, 2003 under the International Convention.

### BACKGROUND OF THE INVENTION

1. Field of the Invention

The invention relates to a lever apparatus in a motor vehicle.

2. Description of the Related Art

A lever apparatus of the generic type is known from DE 34 13 030 C2. A lever apparatus is described there which is represented by a foot-operated parking brake and essentially contains a pedal which forms an actuating lever of the lever apparatus. This actuating lever is mounted rotatably about an axis on a base plate forming a carrier component. The base plate itself is secured on the bodywork. Although it is not explicitly shown here, it is generally customary, as bearing element for the pedal, to provide a spindle made from solid material or a tube which is welded or riveted to the carrier component. The pedal is pivotable about this bearing element. A lever apparatus of this type is relatively complicated to produce and therefore relatively cost-intensive. Furthermore, the lever apparatus, in particular the bearing element, has a considerable weight.

### SUMMARY OF THE INVENTION

The invention is based on the object of developing a lever apparatus according to the generic type to the effect that the production thereof is simplified.

Owing to the design of the bearing element as a hollow sheet metal part with laterally protruding supporting means, the bearing element can be securely held in a simple manner on the carrier component by virtue of being supported on the rear side of this component by means of the supporting means, on the one hand, and, on the other hand, via a retaining part which has to be present in any case in order to captively arrange the actuating lever on the bearing element, and is situated on that side of the carrier component which lies opposite the supporting means. This significantly simplifies the production of the lever apparatus, since the previously known, complicated joining processes, such as welding and riveting, can be dispensed with. For this, the bearing element has to be pushed through the opening of the carrier component in a simple manner until it bears with its supporting means against the rear side of the carrier component, after which the actuating lever is pushed onto the bearing element on the opposite side and the retaining part is subsequently fitted on the bearing element in such a manner that neither the actuating lever, on the one hand, nor the bearing element, on the other hand, can drop out of the assembly. Owing to the formation of an opening in the carrier component and owing to the design of the bearing element as a hollow sheet metal part, the weight of the lever apparatus is considerably reduced and the production costs thereof minimized. The lever apparatus may be used, for example, in the case of pedals of the pedal apparatus in the foot well of the motor vehicle and in the case of the foot-operated parking brake and in the case of the handbrake.

In a preferred development of the invention, the supporting means is an annular collar which is formed on the bearing element. By means of the annular collar, the bearing element obtains an extensive support over a wide area and considerably increases its inherent rigidity. Although the annular collar may be formed by a separate component which is then fastened to the bearing element, it is more favorable for strength reasons and for reasons concerned with the simplified production if the annular collar is formed as a single piece with the bearing element. It may be integrally formed on the bearing element or may be shaped out of the latter.

In a further preferred refinement of the invention, the supporting means is formed at one end of the bearing element. Since the hollow sheet metal part which forms the bearing element does not protrude in the axial direction over the supporting means on the rear side of the carrier component, construction space for the lever apparatus in the motor vehicle is saved if said lever apparatus is to be secured on the bodywork on the side of the rear side of the carrier component. In the event of the carrier component having to be secured on the bodywork, for example by means of welding or screwing, its vicinity to the bodywork means that no particularly complicated configuration of the joining surfaces of the carrier component is required. The obtained gain in construction space enables further add-on parts to be placed on the bearing element on the side of the actuating lever, such as, for example, a pivot lever of a device for readjusting the cable pull of the brake which in this case forms the lever apparatus.

In a further preferred development of the invention, the supporting means is additionally joined to the carrier component on the rear side thereof. Although this is not absolutely necessary, this increases the support of the bearing element on the carrier component and prevents an axial slipping of the bearing element, which would possibly lead to an undesired rattling noise.

In a further preferred refinement of the invention, the retaining element is a clamping ring which is pressed onto the bearing element. The abovementioned design of the retaining element also simplifies the production of the lever apparatus, since the bearing element can be of essentially smooth design and it can be made unnecessary to incorporate a securing groove in the bearing element in order to hold a ring. With the clamping ring, pushing on is possible in an infinitely variable manner and nevertheless such that it is accurate in every position, so that the play desired for the actuating lever or in the case of a parking brake or pedal for the actuation thereof can be set.

In this case, the carrier component is designed as a metal sheet. The carrier component can be produced here as a simple pressed part, so that the entire production of the lever apparatus is simplified and its weight reduced from this side too. The opening in the metal sheet to pass the bearing element through may be formed by a punching operation at the same time as the metal sheet is pressed out in a shaping operation.

In a further preferred refinement of the invention, the sleeve-shaped bearing section of the bearing element ends with an end wall at its end which is situated on the side of the actuating lever and simultaneously coincides with the end there of the bearing element. The formation of an end wall at the other end of the bearing element or of its supporting means gives the bearing element additional rigidity, with the end wall extending transversely to the longitudinal extent of the sleeve-shaped bearing section of the bearing element.

In a further expedient refinement of the invention, the end wall has a passage opening. The effect achieved by this is that the lever apparatus is secured on the bodywork in a simple manner by the bearing element being screwed to a wall of the bodywork, the passage opening serving for the passage of a screw which is screwed into a thread of the wall of the bodywork and which bears with its head against the end wall of the bearing element. The joining surfaces, which otherwise have to be provided on the carrier component in order to connect the lever apparatus to the wall of the bodywork, can now be omitted, which further simplifies the manufacturing of the lever apparatus. Furthermore, the installation is also considerably reduced in terms of the expenditure on time and equipment.

In this case, the transition of the cylindrical shape of the bearing section to the end wall is rounded. By means of the relatively large radii which occur in this case at said transition, the actuating lever and possibly also other add-on parts can be pushed onto the bearing element without being damaged by sharp edges thereof.

In a further, particularly preferred refinement of the invention, the bearing element is a deep drawn part. By this means, the bearing element can be produced in a particularly simple manner from a simple sheet billet or sheet billet blank in the manner of a drawing operation resulting in the formation of a pot or cup, with the supporting means or the supporting means and the end wall also being produced at the same time during the deep drawing operation so as to form the cavity in the bearing element. In this case, the supporting means is formed by the sheet billet edge which is clamped between the holding-down means and the draw die, as a result of which said edge, which is generally severed as scrap after the end of the deep drawing process, now remains on the component formed, so that resources are saved and, furthermore, the meaningful function, namely of supporting the bearing element, is obtained. The cup or pot bottom of the drawn component forms the end wall. The rounded transition of the cylindrical shape of the bearing section to the end wall takes place automatically in a manner caused by the process. The selection of the production process of the bearing element in the form of deep drawing gives rise in a simple manner to essential and advantageous features of the bearing element, such as the supporting means, the end wall and the rounded transition to the end wall, just from the procedure by itself. This quite substantially simplifies the design of the lever apparatus. Furthermore, the deep drawing provides the possibility of making the wall thickness of the bearing element relatively thin by selecting a sheet billet with a low wall thickness. This firstly saves material and considerably reduces the weight of the bearing element.

### BRIEF DESCRIPTION OF THE DRAWINGS

The invention is explained in more detail below with reference to an exemplary embodiment which is illustrated in the drawings, in which:

FIG. 1 shows, in a lateral view, a lever apparatus according to the invention which is formed here by a foot-operated parking brake which contains a device for readjusting the cable pull of the brake,

FIG. 2 shows, in a partial cross section, the lever apparatus from FIG. 1.

### DETAILED DESCRIPTION OF THE INVENTION

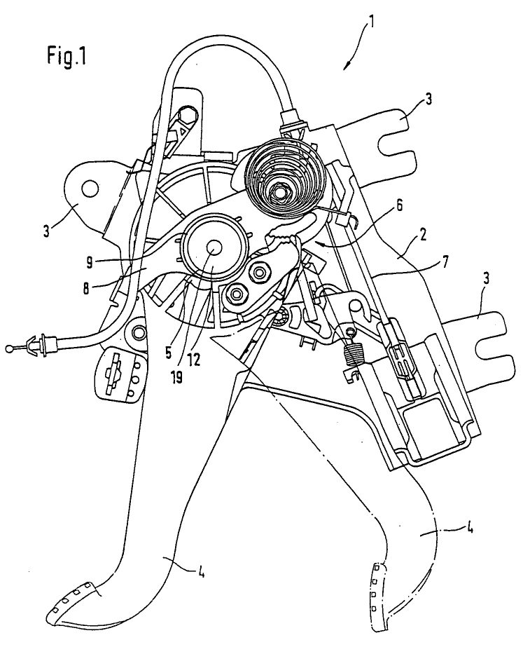

FIG. 1 illustrates a lever apparatus 1 in a motor vehicle, the lever apparatus containing a metal sheet which is designed as the carrier component 2 and by means of which the lever apparatus 1 can be secured on the bodywork via screwing tabs 3 formed on the carrier component 2. The lever apparatus 1, which serves as a foot-operated parking brake, furthermore has an actuating lever 4 which is designed as a pedal and is fastened pivotably on a bearing element 5. The lever apparatus 1 furthermore contains a device 6 for readjusting the cable pull 7 or the brake cable, which is fastened thereto, of the parking brake, a pivot lever 8 of which device 6, like the actuating lever 4, is arranged pivotably on the bearing element 5. The actuating lever 4 and the pivot lever 8 are held captively on the bearing element 5 by means of a clamping ring 9 which is pressed on in the end region there of the bearing element 5 and forms a retaining element for them.

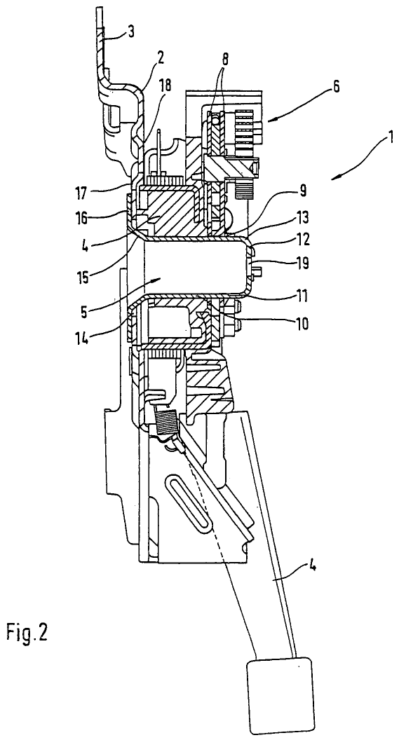

As can be gathered from FIG. 2, the bearing element 5 is formed by a hollow sheet metal part. The bearing element 5 is produced by deep drawing, as a result of which a sleeve-shaped bearing section 10 is formed which bears the actuating lever 4 and the pivot lever 8. The end 11 of the bearing section 10 that is situated on the side of the actuating lever 4 and simultaneously coincides with the end there of the bearing element 5 ends with an end wall 12 which runs transversely to the longitudinal extent of the sleeve shape of the bearing section 10. The transition 13 of the cylindrical shape of the sleeve-shaped bearing section 10 to the end wall 12 is rounded. The bearing element 5, which, owing to its particularly simple capability of being produced by means of the deep drawing, leads to an optimization of the costs of the production of the entire lever apparatus 1, protrudes through an opening 14 in the carrier component 2. In the opening region, the bearing element 5 expands in the manner of a collar, starting from the sleeve-shaped bearing section 10, and ends at its end 15 there in an annular collar 16. The annular collar 16 forms a laterally protruding supporting means of the bearing element 5, said supporting means bearing against the rear side 17 of the carrier component 2. Furthermore, the annular collar 16 can additionally be joined to the carrier component 2 on the rear side 17 thereof by welding, adhesive bonding or similar processes. The distance between the clamping ring 9 and the annular collar 16 is created in such a manner that the pivot lever 8 and the actuating lever 4 on the bearing element 5 are enclosed axially and with little play between the front side 18 of the carrier component 2 and the clamping ring 9. The bearing element 5 furthermore has, in the end wall 12 of the bearing section 10, a passage opening 19 which serves for the passage of a screw shank in the event of the intention being to secure the lever apparatus on the bodywork by means of a screw instead of via the carrier component 2. The bearing element 5 is clamped here between the bodywork and the screw head.

Within the scope of the invention, a multiplicity of variants of the described exemplary embodiment is conceivable. For example, the carrier component 2 may be composed of a hollow profile, with the latter inevitably having to have two openings 14 through which the bearing element 5 can protrude. Also, the supporting means does not inevitably have to be an annular collar 16 which is formed on the bearing element 5. On the contrary, the arrangement of flange-like tabs which are shaped from the bearing element 5 or adjoined as separate components is possible. Furthermore, the annular collar 16 may also be formed by a separate component which is connected to the bearing element 5. Furthermore, the supporting means may also be formed or arranged at a distance from the end 15 of the bearing element 5. Also, alternatives to the clamping ring 9 are conceivable; for example, after the pivot lever 8 and the actuating lever 4 are pushed on, the bearing element 5 may be upset. The bearing element 5 itself may be produced by rolling and longitudinal welding of a suitably designed sheet billet blank instead of by deep drawing, in which case the end wall 12 of the bearing section 10 would therefore be omitted. Furthermore, this end wall 12 may also be completely closed. These alternatives, cited by way of example, to the exemplary embodiment described in detail constitute just one extract from the abovementioned multiplicity of possibilities of refining the invention.

1. A lever apparatus in a motor vehicle, with a carrier component holding a bearing element on which an actuating lever of the lever apparatus is pivotably fastened, wherein the carrier component (2) has an opening (14) through which the bearing element (5) protrudes, in that the bearing element (5) is a hollow sheet metal part which has at least one laterally protruding supporting means (16) which bears against a rear side (17) of the carrier component (2), and wherein the actuating lever (4) on the bearing element (5) is axially enclosed between the front side (18) of the carrier component (2) and a retaining part (9) arranged on the bearing element (5).

2. The lever apparatus as claimed in claim 1, wherein the supporting means (16) is an annular collar which is formed on the bearing element (5).

3. The lever apparatus as claimed in claim 1, wherein the supporting means (16) is formed at one end (15) of the bearing element (5).

4. The lever apparatus as claimed in claim 1, wherein the supporting means (16) is additionally joined to the carrier component (2) on the rear side (17) thereof.

5. The lever apparatus as claimed in claim 1, wherein the retaining element (9) is a clamping ring which is pressed onto the bearing element (5).

6. The lever apparatus as claimed in claim 1, wherein the carrier component (2) is a metal sheet.

7. The lever apparatus as claimed in claim 1, wherein the sleeve-shaped bearing section (10) of the bearing element (5) ends with an end wall (12) at its end (11) which is situated on the side of the actuating lever (4) and simultaneously coincides with the end there of the bearing element (5).

8. The lever apparatus as claimed in claim 7, wherein the end wall (12) has a passage opening (19).

9. The lever apparatus as claimed in claim 7, wherein the transition (13) of the cylindrical shape of the bearing section (10) to the end wall (12) is rounded.

10. The lever apparatus as claimed in claim 1, wherein the bearing element (5) is a deep drawn part.
